(19) United States
(12) Patent Application Publication
(10) Pub. No.: US 2025/0121825 A1
(43) Pub. Date: Apr. 17, 2025

(54) CONTROLLING AN ADAPTIVE CRUISE CONTROL SYSTEM

(71) Applicant: Toyota Motor Engineering & Manufacturing North America, Inc., Plano, TX (US)

(72) Inventors: Amr Abdelraouf, Redwood City, CA (US); Rohit Gupta, Santa Clara, CA (US); Kyungtae Han, Palo Alto, CA (US); Tomohiro Matsuda, Toyotashi (JP); Nicholas E. Merkel, Canton, MI (US); Matthew J. Hill, Ypsilanti, MI (US); Samanthule Nola, Ann Arbor, MI (US); Onur Altintas, Sunnyvale, CA (US); John Kenney, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/613,323

(22) Filed: Mar. 22, 2024

Related U.S. Application Data
(60) Provisional application No. 63/590,797, filed on Oct. 17, 2023.

(51) Int. Cl. B60W 30/16; B60W 50/10

(52) U.S. Cl. CPC B60W 30/16; B60W 50/10; B60W 2754/30

(57) ABSTRACT

A system for controlling an adaptive cruise control system can include a processor and a memory. The memory can store an override ascertainment module, an intent ascertainment module, and an intent utilization module. The override ascertainment module can include instructions that cause the processor to determine, during an operation of the adaptive cruise control system, that an action, performed by an operator of an ego vehicle, is an override of the adaptive cruise control system. The intent ascertainment module can include instructions that cause the processor to determine, during the override, an intent of the operator to change a setting of a mechanism, of the adaptive cruise control system, to control a motion-related aspect of the ego vehicle, from a current setting to a preferred setting. The intent utilization module can include instructions that cause the processor to cause the adaptive cruise control system to utilize information about the intent.

### TECHNICAL FIELD

This application claims the benefit of U.S. Provisional Application No. 63/590,797, filed Oct. 17, 2023, which is incorporated herein in its entirety by reference.

### TECHNICAL FIELD

The disclosed technologies are directed to controlling an adaptive cruise control system.

### BACKGROUND

A cruise control system can control a speed of an ego vehicle. An operator of the ego vehicle can set the speed. The cruise control system can include a servomechanism to control a position of a throttle of the ego vehicle to maintain the speed. Advantages of a cruise control system can include, for example, one or more of a reduction in a degree of fatigue of the operator of the ego vehicle, an assurance that the speed of the ego vehicle is less than a regulatory speed limit, an increase in a fuel efficiency of the ego vehicle, or the like. More recently, technologies for cruise control have been developed so that a cruise control system can control a braking system of the ego vehicle, in conjunction with control of the position of the throttle, to maintain a distance (e.g., a gap) between the ego vehicle and a preceding vehicle. Such a cruise control system can be referred to as an adaptive cruise control (ACC) system.

### SUMMARY

In an embodiment, a system for controlling an adaptive cruise control system can include a processor and a memory. The memory can store an override ascertainment module, an intent ascertainment module, and an intent utilization module. The override ascertainment module can include instructions that, when executed by the processor, cause the processor to determine, during an operation of the adaptive cruise control system, that an action, performed by an operator of an ego vehicle, is an override of the adaptive cruise control system. The intent ascertainment module can include instructions that, when executed by the processor, cause the processor to determine, during the override, an intent of the operator to change a setting of a mechanism, configured to control a motion-related aspect of the ego vehicle, from a current setting to a preferred setting. The mechanism can be of the adaptive cruise control system. The intent utilization module can include instructions that, when executed by the processor, cause the processor to cause the adaptive cruise control system to utilize information about the intent.

In another embodiment, a method for controlling an adaptive cruise control system can include determining, by a processor during an operation of the adaptive cruise control system, that an action, performed by an operator of an ego vehicle, is an override of the adaptive cruise control system. The method can include determining, by the processor and during the override, an intent of the operator to change a setting of a mechanism, configured to control a motion-related aspect of the ego vehicle, from a current setting to a preferred setting. The mechanism can be of the adaptive cruise control system. The method can include causing, by the processor, the adaptive cruise control system to utilize information about the intent.

In another embodiment, a non-transitory computer-readable medium for controlling an adaptive cruise control system can include instructions that, when executed by one or more processors, cause the one or more processors to determine, during an operation of an adaptive cruise control system, that an action, performed by an operator of an ego vehicle, is an override of the adaptive cruise control system. The non-transitory computer-readable medium can include instructions that, when executed by one or more processors, cause the one or more processors to determine, during the override, an intent of the operator to change a setting of a mechanism, configured to control a motion-related aspect of the ego vehicle, from a current setting to a preferred setting. The mechanism can be of the adaptive cruise control system. The non-transitory computer-readable medium can include instructions that, when executed by one or more processors, cause the one or more processors to cause the adaptive cruise control system to utilize information about the intent.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram that illustrates an example of an environment for controlling an adaptive cruise control system, according to the disclosed technologies.

FIG. 2 includes a diagram that illustrates an example of a vehicle that can be configured to control an adaptive cruise control system, according to the disclosed technologies.

FIG. 3 includes a block diagram that illustrates an example of a system for controlling an adaptive cruise control system, according to the disclosed technologies.

FIG. 4 includes a graph of a speed, versus time, of an ego vehicle, according to a first realization of a first implementation of the disclosed technologies.

FIG. 5 includes a graph of a speed, versus time, of an ego vehicle, according to a second realization of the first implementation of the disclosed technologies.

FIG. 6 includes a graph of a speed, versus time, of an ego vehicle, according to a third realization of the first implementation of the disclosed technologies.

FIG. 7 includes a graph of a speed, versus time, of an ego vehicle, according to a fourth realization of the first implementation of the disclosed technologies.

FIG. 8 includes a diagram that illustrates a first example of a database of an adaptive cruise control system, according to the disclosed technologies.

FIG. 9 includes a diagram that illustrates a second example of the database of the adaptive cruise control system, according to the disclosed technologies.

FIG. 10 includes a diagram that illustrates a third example of the database of the adaptive cruise control system, according to the disclosed technologies.

FIG. 11 includes a diagram that illustrates a fourth example of the database of the adaptive cruise control system, according to the disclosed technologies.

FIG. 12 includes a diagram that illustrates a first example of another database of the adaptive cruise control system, according to the disclosed technologies.

FIG. 13 includes a diagram that illustrates a second example of the other database of the adaptive cruise control system, according to the disclosed technologies.

FIG. 14 includes a flow diagram that illustrates an example of a method that is associated with controlling an adaptive cruise control system, according to the disclosed technologies.

FIG. 15 includes a block diagram that illustrates an example of elements disposed on a vehicle, according to the disclosed technologies.

### DETAILED DESCRIPTION

The disclosed technologies can control an adaptive cruise control (ACC) system. A first action, performed by an operator of an ego vehicle during an operation of the ACC system, can be determined to be an override of the ACC system. For example, the first action can include one or more of an action, via: (1) a braking operator interface, to cause the ego vehicle to brake or (2) an accelerating operator interface, to cause the ego vehicle to accelerate. For example, the braking operator interface can include a brake pedal or a joystick-like control lever. For example, the accelerating operator interface can include an accelerator pedal or a joystick-like control lever. During the override, an intent of the operator to change a setting of a mechanism from a current setting to a preferred setting can be determined. The mechanism can be of the ACC system and can be configured to control a motion-related aspect of the ego vehicle. For example, the motion-related aspect of the ego vehicle can be: (1) a gap between the ego vehicle and a preceding vehicle or (2) a rate of a change of a speed of the ego vehicle.

For example, the first action can be determined to be an override of the ACC system by determining that the first action is performed for a duration of time greater than a threshold duration of time (e.g., one second). As an alternative, for example, the first action can be determined to be an override of the ACC system by determining that the first action is, within a duration of time less than a threshold duration of time (e.g., two seconds), repeated. Such determinations can prevent having an anomalous action be determined to be an override of the ACC system. As another alternative, for example, the first action can be determined to be an override of the ACC system by determining that the first action is performed for a duration of time less than a threshold duration of time (e.g., three seconds). Such a determination can distinguish an override of the ACC system performed: (1) so that the intent of the operator to change the setting of the mechanism is to be determined from (2) to transfer control of the ego vehicle from the ACC system to the operator.

For example, if the motion-related aspect of the ego vehicle is the gap between the ego vehicle and the preceding vehicle, then: (1) the current setting can be for a first gap maintained, by the ACC system, between the ego vehicle and the preceding vehicle and (2) the preferred setting can be for a second gap to be maintained, by the ACC system, between the ego vehicle and the preceding vehicle.

For example, if the motion-related aspect of the ego vehicle is the rate of the change of the speed of the ego vehicle, then: (1) the current setting can be for a first rate, controlled by the ACC system, of the change of the speed of the ego vehicle and (2) the preferred setting can be for a second rate, to be controlled by the ACC system, of the change of the speed of the ego vehicle.

The ACC system can be caused to utilize information about the intent of the operator. For example, the ACC system can be caused to utilize the information about the intent of the operator by causing a resumption of the operation of the ACC system. For example, the ACC system can include a database that has a record in which the current setting can be changed to the preferred setting. For example, the ACC system can be caused to resume operation after the current setting has been changed to the preferred setting. Alternatively, for example, the ACC system can be caused to resume operation in response to a second action performed by the operator. For example, the second action can include one or more of an action, via: (1) an ACC operator interface, to cause the resumption of the operation of the ACC system, (2) a braking operator interface, to cause the ego vehicle to brake or (3) an accelerating operator interface, to cause the ego vehicle to accelerate. For example, the ACC operator interface can include a resume button.

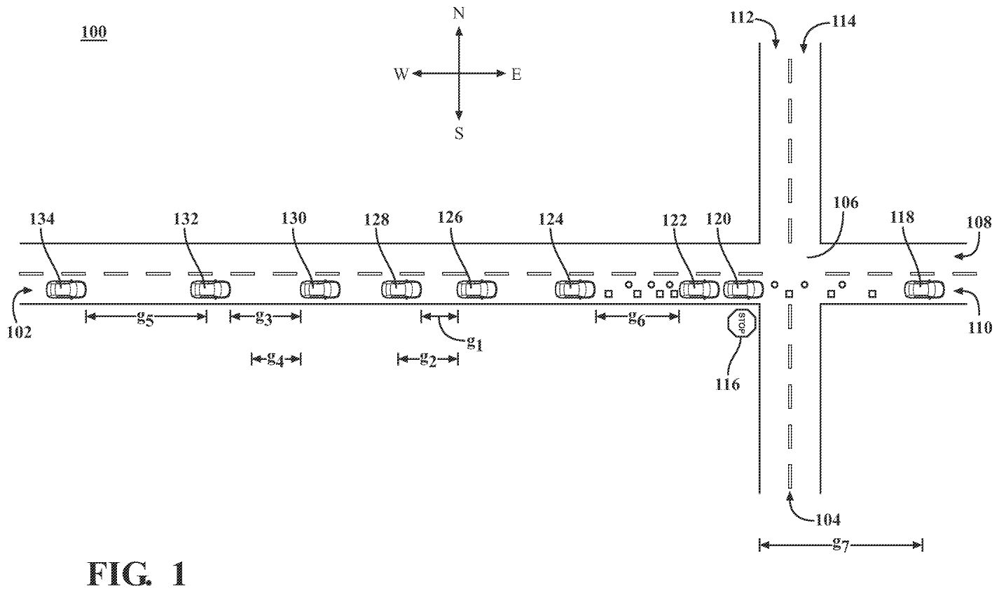

FIG. 1 includes a diagram that illustrates an example of an environment 100 for controlling an adaptive cruise control system, according to the disclosed technologies. For example, the environment 100 can include a first road 102 (disposed along a line of latitude) and a second road 104 (disposed along a line of longitude). For example, the environment 100 can include a road junction 106 of the first road 102 and the second road 104. For example, the first road 102 can include a westbound lane 108 and an eastbound lane 110. For example, the second road 104 can include a southbound lane 112 and a northbound lane 114. For example, the environment 100 can include a stop sign 116 at a southwest corner of the road junction 106.

For example, the environment 100 can include: (1) a first vehicle 118 in the eastbound lane 110 east of the road junction 106, (2) a second vehicle 120 in the eastbound lane 110 west of the road junction 106 stopped at the stop sign 116, (3) a third vehicle 122 in the eastbound lane 110 west of the second vehicle 120 stopped behind the second vehicle 120, (4) a fourth vehicle 124 in the eastbound lane 110 west of the third vehicle 122, (5) a fifth vehicle 126 in the eastbound lane 110 west of the fourth vehicle 124, (6) a sixth vehicle 128 in the eastbound lane 110 west of the fifth vehicle 126, (7) a seventh vehicle 130 in the eastbound lane 110 west of the sixth vehicle 128, (8) an eighth vehicle 132 in the eastbound lane 110 west of the seventh vehicle 130, and (9) a ninth vehicle 134 in the eastbound lane 110 west of the eighth vehicle 132.

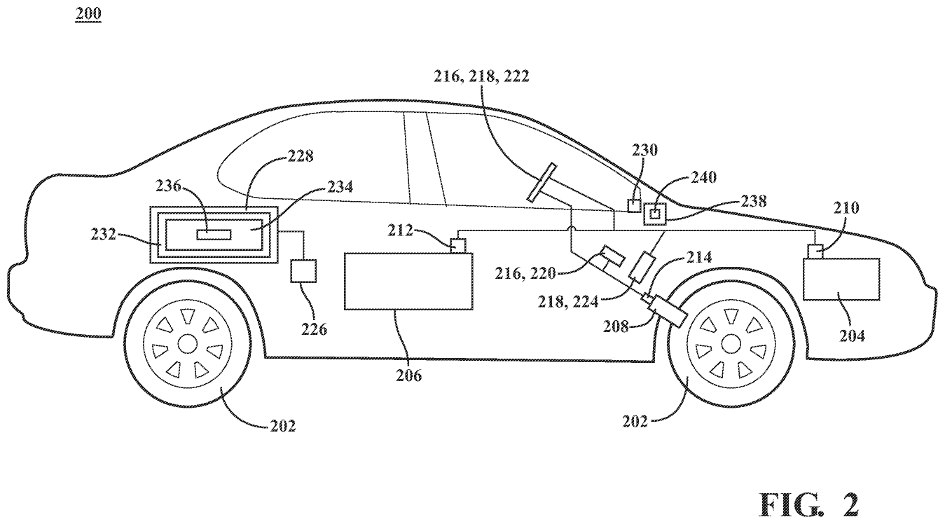

FIG. 2 includes a diagram that illustrates an example of a vehicle 200 that can be configured to control an adaptive cruise control system, according to the disclosed technologies. For example, the vehicle 200 can include one or more wheels 202 and at least one of an internal combustion engine 204 or an electric drive motor 206. For example, the vehicle 200 can include one or more brakes 208 for the one or more wheels 202. For example, the vehicle 200 can include an actuator 210 configured to control a position of a throttle for the internal combustion engine 204 (e.g., if the vehicle 200 is capable of being propelled by the internal combustion engine 204), an actuator 212 configured to control an amount of current conveyed to the electric drive motor 206 (e.g., if the vehicle 200 is capable of being propelled by the electric drive motor 206), and an actuator 214 configured to control the one or more brakes 208. For example, the vehicle 200 can include a braking operator interface 216 and an accelerating operator interface 218. For example, the braking operator interface 216 can include a brake pedal 220. Alternatively, for example, the braking operator interface 216 can include a joystick-like control lever 222. For example, the accelerating operator interface 218 an accelerator pedal 224. Alternatively, for example, the accelerating operator interface 218 can include the joystick-like control lever 222. For example, the vehicle 200 can include a processor 226 and a memory 228. For example, the vehicle 200 can include a sensor 230. For example, the sensor 230 can be configured to determine a value of a gap between the vehicle 200 and a preceding vehicle. For example, the vehicle 200 can include an adaptive cruise control (ACC) system 232. For example, the ACC system 232 can include a mechanism 234 configured to control a motion-related aspect of the vehicle 200. For example, the mechanism 234 can include a database 236. For example, the ACC system 232 can include an ACC operator interface 238. For example, the ACC operator interface 238 can include a resume button 240.

With reference to FIGS. 1 and 2, for example, one or more of: (1) the first vehicle 118, (2) the second vehicle 120, (3) the third vehicle 122, (4) the fourth vehicle 124, (5) the fifth vehicle 126, (6) the sixth vehicle 128, (7) the seventh vehicle 130, (8) the eighth vehicle 132, and (9) the ninth vehicle 134 can be the vehicle 200.

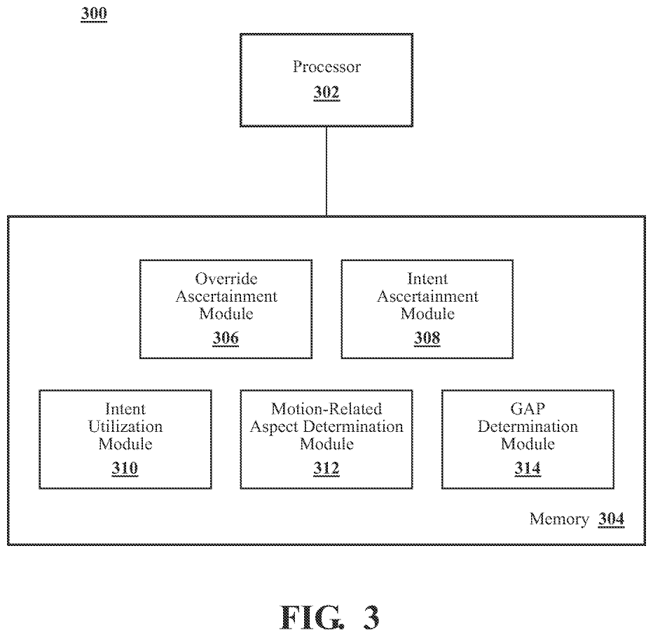

FIG. 3 includes a block diagram that illustrates an example of a system 300 for controlling an adaptive cruise control system, according to the disclosed technologies. The system 300 can include, for example, a processor 302 and a memory 304. The memory 304 can be communicably coupled to the processor 302. For example, the memory 304 can store an override ascertainment module 306, an intent ascertainment module 308, and an intent utilization module 310. For example, the processor 302 can be the processor 226 illustrated in FIG. 2. For example, the memory 304 can be the memory 228 illustrated in FIG. 2. For example, the adaptive cruise control system (ACC) can be the ACC system 232 illustrated in FIG. 2.

For example, the override ascertainment module 306 can include instructions that function to control the processor 302 to determine, during an operation of the ACC system, that a first action, performed by an operator of an ego vehicle, is an override of the ACC system.

For example, the first action can include one or more of an action, via: (1) a braking operator interface, to cause the ego vehicle to brake or (2) an accelerating operator interface, to cause the ego vehicle to accelerate. For example, the braking operator interface can be the braking operator interface 216 illustrated in FIG. 2. For example, the accelerating operator interface can be the accelerating operator interface 218 illustrated in FIG. 2.

For example, one or more of: (1) the braking operator interface can include a brake pedal or (2) the accelerating operator interface can include an accelerator pedal. For example, the brake pedal can be the brake pedal 220 illustrated in FIG. 2. For example, the accelerator pedal can be the accelerator pedal 224 illustrated in FIG. 2.

Additionally or alternatively, for example, one or more of: (1) the braking operator interface can include a joystick-like control lever or (2) the accelerating operator interface can include the joystick-like control lever. For example, the joystick-like control lever can be the joystick-like control lever 222 illustrated in FIG. 2.

For example, in a first realization of a first implementation of the disclosed technologies, the instructions to determine that the first action is an override of an ACC system can include instructions to determine that the first action is performed for a duration of time greater than a threshold duration of time. For example, the threshold duration of time can be one second. That is, having the first action performed for a duration of time that is greater than a threshold duration of time can be indicative, for example, that the first action was not anomalous.

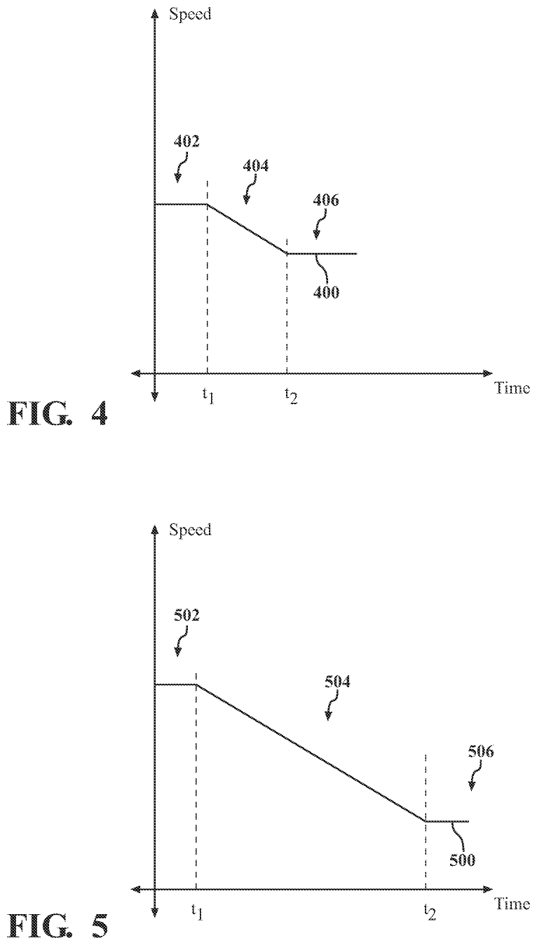

FIG. 4 includes a graph 400 of a speed, versus time, of an ego vehicle, according to a first realization of a first implementation of the disclosed technologies. For example, the graph 400 can have a first phase 402, a second phase 404, and a third phase 406. For example, during the first phase 402, the speed of the ego vehicle can be a constant first speed. For example, the second phase 404 can start at a first time (t₁) and end at a second time (t₂). For example, the second phase 404 can be characterized by a reduction of the speed of the ego vehicle from the constant first speed to a constant second speed. For example, during the third phase 406, the speed of the ego vehicle can be the constant second speed. For example, if a duration of time from the first time (t₁) to the second time (t₂) is greater than a threshold duration of time (e.g., one second), then an action that caused the reduction of the speed of the ego vehicle can be determined to be an override of an ACC system.

For example, in a second realization of the first implementation of the disclosed technologies, the instructions to determine that the first action is an override of an ACC system can include instructions to determine that the first action is performed for a duration of time less than a threshold duration of time. For example, the threshold duration of time can be three seconds. That is, having the first action performed for a duration of time that is greater than a threshold duration of time can be indicative, for example, that the first action was not performed to be an override of an ACC system.

FIG. 5 includes a graph 500 of a speed, versus time, of an ego vehicle, according to a second realization of the first implementation of the disclosed technologies. For example, the graph 500 can have a first phase 502, a second phase 504, and a third phase 506. For example, during the first phase 502, the speed of the ego vehicle can be a constant first speed. For example, the second phase 504 can start at a first time (t₁) and end at a second time (t₂). For example, the second phase 504 can be characterized by a reduction of the speed of the ego vehicle from the constant first speed to a constant second speed. For example, during the third phase 506, the speed of the ego vehicle can be the constant second speed. For example, if a duration of time from the first time (t₁) to the second time (t₂) is greater than a threshold duration of time (e.g., three seconds), then an action that caused the reduction of the speed of the ego vehicle can be determined not to be an override of an ACC system.

For example, in a third realization of the first implementation of the disclosed technologies, the instructions to determine that the first action is an override of an ACC system can include instructions to determine that the first action is, within a duration of time less than a threshold duration of time, repeated. For example, the threshold duration of time can be two seconds. That is, having the first action, within a duration of time that is less than a threshold duration of time, repeated can be indicative, for example, that the first action was performed to be an override of an ACC system.

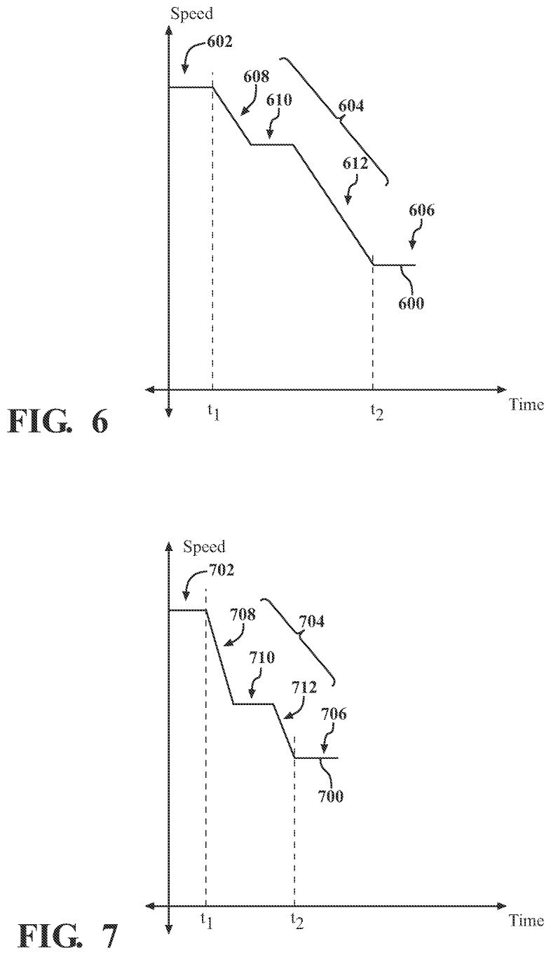

FIG. 6 includes a graph 600 of a speed, versus time, of an ego vehicle, according to a third realization of the first implementation of the disclosed technologies. For example, the graph 600 can have a first phase 602, a second phase 604, and a third phase 606. For example, during the first phase 602, the speed of the ego vehicle can be a constant first speed. For example, the second phase 604 can start at a first time (t₁) and end at a second time (t₂). For example, the second phase 604 can have a first sub-phase 608, a second sub-phase 610, and a third sub-phase 612. For example, the first sub-phase 608 can be characterized by a reduction of the speed of the ego vehicle from the constant first speed to a constant second speed. For example, during the second sub-phase 610, the speed of the ego vehicle can be the constant second speed. For example, the third sub-phase 612 can be characterized by a reduction of the speed of the ego vehicle from the constant second speed to a constant third speed. For example, during the third phase 606, the speed of the ego vehicle can be the constant third speed. For example, if a duration of time from the first time (t₁) to the second time (t₂) is less than a threshold duration of time (e.g., two seconds), then having an action that caused the reduction of the speed of the ego vehicle repeated within the duration of time can be determined to be an override of an ACC system.

For example, in a fourth realization of the first implementation of the disclosed technologies, the instructions to determine that the first action is an override of an ACC system can include instructions to determine that the first action is, within a duration of time less than a threshold duration of time, repeated greater than a threshold number of times. For example, the threshold duration of time can be one second. For example, the threshold number of times can be one. That is, having the first action, within a duration of time that is less than a threshold duration of time, repeated greater than a threshold number of times can be indicative, for example, that the first action was performed to be an override of an ACC system.

FIG. 7 includes a graph 700 of a speed, versus time, of an ego vehicle, according to a fourth realization of the first implementation of the disclosed technologies. For example, the graph 700 can have a first phase 702, a second phase 704, and a third phase 706. For example, during the first phase 702, the speed of the ego vehicle can be a constant first speed. For example, the second phase 704 can start at a first time (t₁) and end at a second time (t₂). For example, the second phase 704 can have a first sub-phase 708, a second sub-phase 710, and a third sub-phase 712. For example, the first sub-phase 708 can be characterized by a reduction of the speed of the ego vehicle from the constant first speed to a constant second speed. For example, during the second sub-phase 710, the speed of the ego vehicle can be the constant second speed. For example, the third sub-phase 712 can be characterized by a reduction of the speed of the ego vehicle from the constant second speed to a constant third speed. For example, during the third phase 706, the speed of the ego vehicle can be the constant third speed. For example, if a duration of time from the first time (t₁) to the second time (t₂) is less than a threshold duration of time (e.g., one second), then having an action that caused the reduction of the speed of the ego vehicle repeated greater than a threshold number of times (e.g., one) within the duration of time can be determined to be an override of an ACC system.

Returning to FIG. 3, for example, the intent ascertainment module 308 can include instructions that function to control the processor 302 to determine, during the override of the ACC system, an intent of the operator to change a setting of a mechanism, configured to control a motion-related aspect of the ego vehicle, from a current setting to a preferred setting. For example, the mechanism can be of the adaptive cruise control system.

For example, the intent utilization module 310 can include instructions that function to control the processor 302 to cause the ACC system to utilize information about the intent of the operator.

For example, in a second implementation of the disclosed technologies, the motion-related aspect of the ego vehicle can be a gap between the ego vehicle and a preceding vehicle. For example, the current setting can be for a first gap maintained, by the ACC system, between the ego vehicle and the preceding vehicle. For example, the preferred setting can be for a second gap to be maintained, by the ACC system, between the ego vehicle and the preceding vehicle. For example, the memory 304 can further store a motion-related aspect determination module 312. For example, the motion-related aspect determination module 312 can include instructions that function to control the processor 302 to determine that the motion-related aspect of the ego vehicle is the gap between the ego vehicle and the preceding vehicle.

With reference to FIG. 1, for example: (1) the ego vehicle can be the sixth vehicle 128, (2) the preceding vehicle can be the fifth vehicle 126, (3) the current setting, for the first gap maintained by the ACC system between the sixth vehicle 128 and the fifth vehicle 126 can be the gap g₁, and (4) the preferred setting, for the second gap to be maintained by the ACC system between the sixth vehicle 128 and the fifth vehicle 126 can be the gap g₂. Alternatively, for example: (1) the ego vehicle can be the eighth vehicle 132, (2) the preceding vehicle can be the seventh vehicle 130, (3) the current setting, for the first gap maintained by the ACC system between the eighth vehicle 132 and the seventh vehicle 130 can be the gap g₃, and (4) the preferred setting, for the second gap to be maintained by the ACC system between the eighth vehicle 132 and the seventh vehicle 130 can be the gap g₄.

Returning to FIG. 3, for example, in a first realization of the second implementation of the disclosed technologies, the instructions to determine that the motion-related aspect of the ego vehicle is the gap between the ego vehicle and the preceding vehicle can include instructions to determine that the gap between the ego vehicle and the preceding vehicle is less than a threshold gap. For example, the threshold gap can be a specific value. For example, the specific value can be 750 feet. Alternatively, for example, the threshold gap can be a function of a speed of the ego vehicle. That is, having the gap between the ego vehicle and the preceding vehicle be greater than a threshold gap can be indicative, for example, that the motion-related aspect of the ego vehicle is not the gap between the ego vehicle and the preceding vehicle.

With reference to FIG. 1, for example, the ego vehicle can be the ninth vehicle 134, the preceding vehicle can be the eighth vehicle 132, and the gap g₅ between the ninth vehicle 134 and the eighth vehicle 132 can be greater than the threshold gap, which can be indicative that the motion-related aspect of the ninth vehicle 134 is not the gap between the ninth vehicle 134 and the eighth vehicle 132.

Returning to FIG. 3, for example, in a second realization of the second implementation of the disclosed technologies, the ACC system can include a database that has records with a first field and a second field. For example, the first field can be for values of speeds of the ego vehicle. For example, the second field can be for values of settings for gaps to be maintained between the ego vehicle and the preceding vehicle.

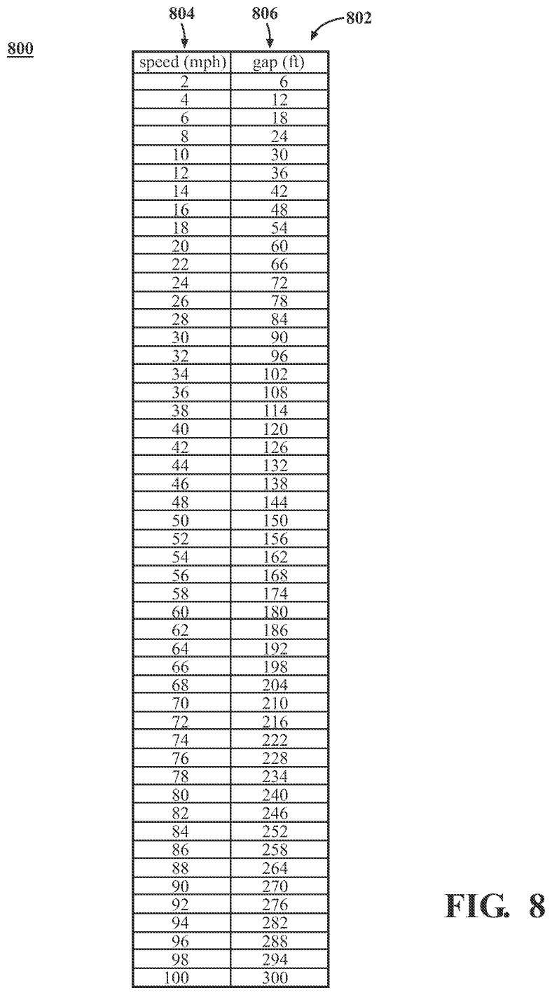

FIG. 8 includes a diagram that illustrates a first example 800 of a database 802 of an adaptive cruise control system, according to the disclosed technologies. For example, the database 802 can be the database 236 illustrated in FIG. 2. For example, the database 802 can include a first field 804 and a second field 806. For example, the first field 804 can be for values of speeds of the ego vehicle. For example, the second field 806 can be for values of settings for gaps to be maintained between the ego vehicle and the preceding vehicle.

Returning to FIG. 3, for example, the instructions to cause the ACC system to utilize the information about the intent of the operator can include: (1) instructions to determine a value of a speed of the ego vehicle during the override, (2) instructions to retrieve, from the database, a record, of the records, in which a value of a speed of the ego vehicle is equal to the value of the speed of the ego vehicle during the override, (3) instructions to overwrite, in the record, a value of a setting for a gap to be maintained between the ego vehicle and the preceding vehicle with a value of the preferred setting, and (4) instructions to cause a resumption of the operation of the ACC system.

With reference to FIG. 8, for example, if: (1) the value of the speed of the ego vehicle during the override is 60 miles per hour, (2) the current setting, for the first gap maintained by the ACC system between the ego vehicle and the preceding vehicle, is 180 feet, and (3) the preferred setting, for the second gap to be maintained by the ACC system between the ego vehicle and the preceding vehicle, is 50 feet, then: (1) the record, in the database 802, in which the value of the speed of the ego vehicle is equal to the value of the speed of the ego vehicle during the override can be the record in which a value of the first field 804 is 60 miles per hour and a value of the second field 806 is 180 feet, (2) the value of the setting for the gap to be maintained between the ego vehicle and the preceding vehicle can be overwritten, in the record, with the value of the preferred setting, 50 feet, and (3) the operation of the ACC system can be resumed.

Returning to FIG. 3, additionally, for example, the instructions to cause the ACC system to utilize the information about the intent of the operator can further include: (5) instructions to compare the value of the preferred setting with a value of a safe setting for the gap to be maintained and (6) instructions to cause, in response to the value of the preferred setting being less than the value of the safe setting, the value of the preferred setting to be the value of the safe setting.

With reference to FIG. 8, for example, if: (1) the value of the preferred setting is 50 feet and (2) the value of the safe setting is 60 feet, then the value of the setting for the gap to be maintained between the ego vehicle and the preceding vehicle to be overwritten in the record is 60 feet.

Returning to FIG. 3, for example, in a first manifestation of the second realization of the second implementation of the disclosed technologies, the instructions to determine the intent of the operator can include instructions to produce a first recording of values of gaps between the ego vehicle and the preceding vehicle. For example, the first recording can start at a time of an initiation of the first action. For example, the first recording can end at a time that is a duration of time after a time of a completion of the first action. For example, the duration of time can be two seconds. For example, the completion of the first action can include one or more of a cessation of an action, via: (1) a braking operator interface, to cause the ego vehicle to brake or (2) an accelerating operator interface, to cause the ego vehicle to accelerate. For example, the instructions to determine the value of the speed of the ego vehicle can include instructions to produce a second recording of the values of the speeds of the ego vehicle. For example, the second recording can start at the time of the initiation of the first action. For example, the second recording can end at the time that is the duration of time after the time of the completion of the first action.

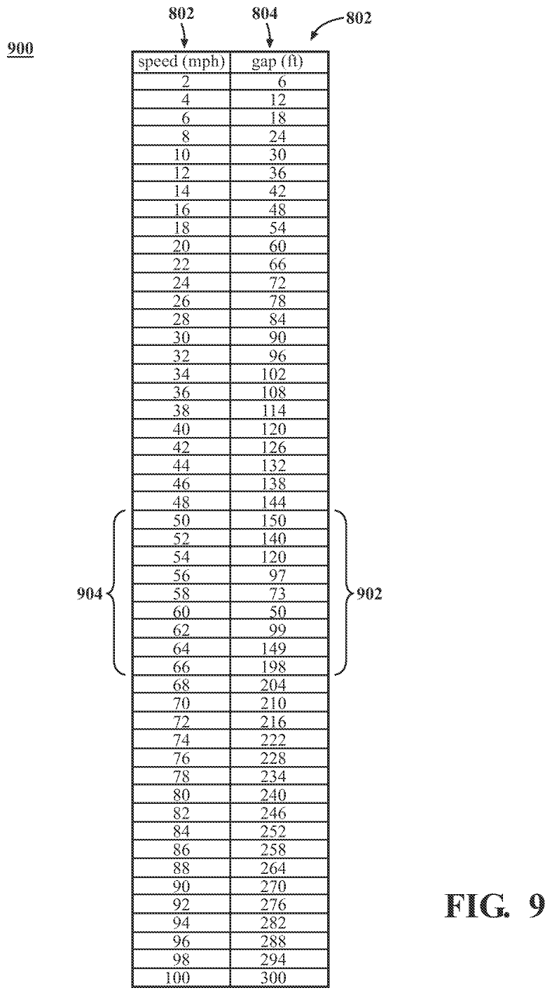

FIG. 9 includes a diagram that illustrates a second example 900 of the database 802 of the adaptive cruise control system, according to the disclosed technologies. The example 900 can include a first recording 902 and a second recording 904. For example, the first recording 902 can be of the values of the gaps between the ego vehicle and the preceding vehicle. For example, the first recording 902 can start at the time of the initiation of the first action. For example, at the time of the initiation of the first action, the value of the gap between the ego vehicle and the preceding vehicle can be 150 feet. For example, the first recording 902 can end at the time that is the duration of time after the time of the completion of the first action. For example, at the time of the completion of the first action, the value of the gap between the ego vehicle and the preceding vehicle can be 50 feet. For example, at the time that is the duration of time after the time of the completion of the first action, the value of the gap between the ego vehicle and the preceding vehicle can be 198 feet. For example, the second recording 904 can be of the values of the speeds of the ego vehicle. For example, the second recording 904 can start at the time of the initiation of the first action. For example, at the time of the initiation of the first action, the value of the speed of the ego vehicle can be 50 miles per hour. For example, the second recording 904 can end at the time that is the duration of time after the time of the completion of the first action. For example, at the time of the completion of the first action, the value of the speed of the ego vehicle can be 60 miles per hour. For example, at the time that is the duration of time after the time of the completion of the first action, the value of the speed of the ego vehicle can be 66 miles per hour.

Returning to FIG. 3, additionally, for example, the instructions to determine the intent of the operator further can include instructions to perform an analysis of the first recording. For example, the analysis of the first recording can be configured to emphasize a value, at the time of the completion of the first action, of a gap between the ego vehicle and the preceding vehicle. That is, the value of the gap, between the ego vehicle and the preceding vehicle, at the time of the completion of the first action can be, for example, most relevant to a determination of the preferred setting for the second gap to be maintained, by the ACC system, between the ego vehicle and the preceding vehicle. For example, the instructions to determine the value of the speed of the ego vehicle can further include instructions to perform an analysis of the second recording. For example, the analysis of the second recording can be configured to emphasize a value, at the time of the completion of the first action, of the speed of the ego vehicle.

Additionally or alternatively, for example, the instructions to cause the ACC system to utilize the information about the intent of the operator can further include instructions to process, with a smoothing filter: (1) the first recording to produce smoothed values of the gaps between the ego vehicle and the preceding vehicle and (2) the second recording to produce smoothed values of the speeds of the ego vehicle. For example, the smoothing filter can be a moving average smoothing filter. For example, the instructions to retrieve the record in which the value of the speed of the ego vehicle is equal to the value of the speed of the ego vehicle during the override can include instructions to retrieve records in which the values of the speeds of the ego vehicle are equal to the smoothed values of the speeds of the ego vehicle. For example, the instructions to overwrite the value of the setting for the gap to be maintained between the ego vehicle and the preceding vehicle can include instructions to overwrite, in the records in which the values of the speeds of the ego vehicle are equal to the smoothed values of the speeds of the ego vehicle, with the smoothed values of the gaps between the ego vehicle and the preceding vehicle.

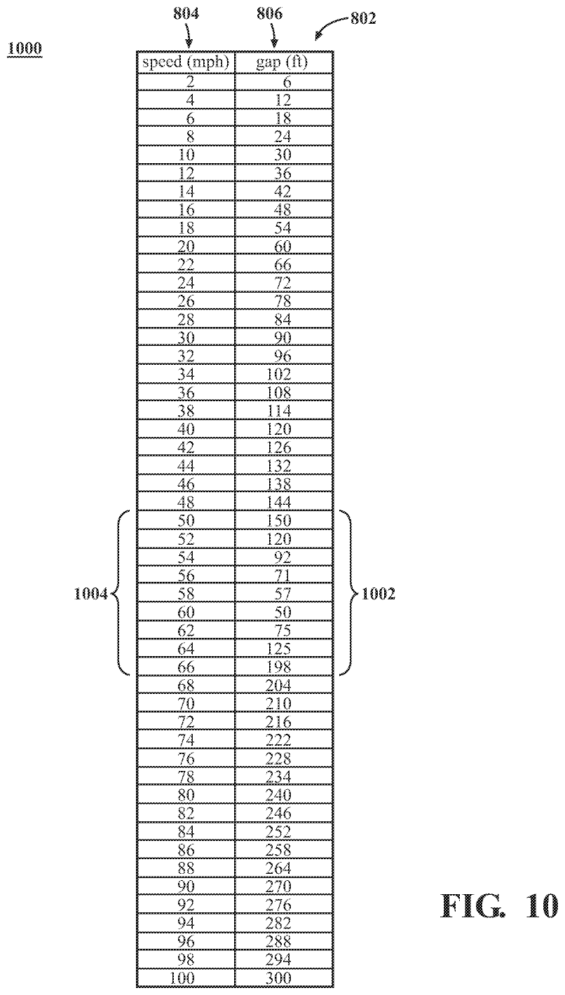

FIG. 10 includes a diagram that illustrates a third example 1000 of the database 802 of the adaptive cruise control system, according to the disclosed technologies. The example 1000 can include a first recording 1002 and a second recording 1004. For example, the first recording 1002 can be of the values of the gaps between the ego vehicle and the preceding vehicle, included in the first recording 902, smoothed with the smoothing filter. For example, the second recording 1004 can be of the values of the speeds of the ego vehicle, included in the second recording 904, smoothed with the smoothing filter. In this manner, changes in the gaps between the ego vehicle and the preceding vehicle can be smoother as the speed of the ego vehicle changes from 50 miles per hour to 66 miles per hour.

For example, in a second manifestation of the second realization of the second implementation of the disclosed technologies, the instructions to retrieve the record in which the value of the speed of the ego vehicle is equal to the value of the speed of the ego vehicle during the override can include instructions to retrieve records in which the values of the speeds of the ego vehicle are between a difference and a sum. For example, the difference can be of a threshold value subtracted from the value of the speed of the ego vehicle during the override. For example, the sum can be of the threshold value added to the value of the speed of the ego vehicle during the override. For example, the threshold value can be ten miles per hour.

With reference to FIG. 8, for example, if: (1) the value of the speed of the ego vehicle during the override is 60 miles per hour and (2) the threshold value is ten miles per hour, then the records retrieved can be the records in which the values of the speeds of the ego vehicle are from 50 miles per hour to 70 miles per hour.

Returning to FIG. 3, for example, the instructions to cause the ACC system to utilize the information about the intent of the operator can further include instructions to process, using a Gaussian process regression technique, values of the settings for the gaps to be maintained between the ego vehicle and the preceding vehicle, in the records in which the values of the speeds of the ego vehicle are between the difference and the sum, to produce updated values of the gaps to be maintained between the ego vehicle and the preceding vehicle. For example, the instructions to overwrite the value of the setting for the gap to be maintained between the ego vehicle and the preceding vehicle can include instructions to overwrite, in the records in which the values of the speeds of the ego vehicle are between the difference and the sum, with the updated values of the gaps to be maintained between the ego vehicle and the preceding vehicle.

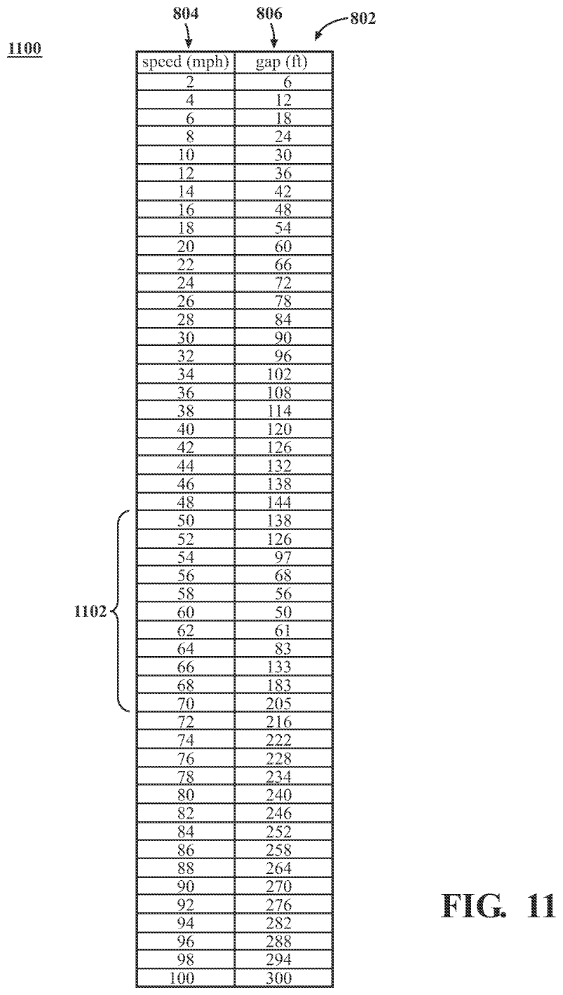

FIG. 11 includes a diagram that illustrates a fourth example 1100 of the database 802 of the adaptive cruise control system, according to the disclosed technologies. The example 1100 can include, in the records 1102 in which the values of the speeds of the ego vehicle are from 50 miles per hour to 70 miles per hour, the updated values, of the gaps to be maintained between the ego vehicle and the preceding vehicle, produced using the Gaussian process regression technique.

Returning to FIG. 3, for example, in a third manifestation of the second realization of the second implementation of the disclosed technologies, the instructions to cause the resumption of the operation of the ACC system can include instructions to cause, after the value of the setting for the gap to be maintained between the ego vehicle and the preceding vehicle has been overwritten with the value of the preferred setting, the resumption of the operation of the ACC system. That is, the resumption of the operation of the ACC system can occur, for example, with no further action, after the value of the setting for the gap to be maintained between the ego vehicle and the preceding vehicle has been overwritten with the value of the preferred setting.

Additionally or alternatively, for example, in a fourth manifestation of the second realization of the second implementation of the disclosed technologies, the instructions to cause the resumption of the operation of the ACC system can include instructions to cause, in response to a second action, performed by the operator, the resumption of the operation of the ACC system. For example, the second action can include one or more of an action, via: (1) an ACC operator interface, to cause the resumption of the operation of the adaptive cruise control system, (2) a braking operator interface, to cause the ego vehicle to brake, or (3) an accelerating operator interface, to cause the ego vehicle to accelerate. For example, the ACC operator interface can include a resume button. For example, the ACC operator interface can be the ACC operator interface 238 illustrated in FIG. 2. For example, the resume button can be the resume button 240 illustrated in FIG. 2. For example, the braking operator interface can be the braking operator interface 216 illustrated in FIG. 2. For example, the accelerating operator interface can be the accelerating operator interface 218 illustrated in FIG. 2.

For example, in a third realization of the second implementation of the disclosed technologies, the memory 304 can further store a gap determination module 314. For example, the gap determination module 314 can include instructions that function to control the processor 302 to determine if the second gap is either less than a first threshold gap or greater than a second threshold gap. For example, the instructions to cause the ACC system to utilize the information about the intent of the operator can include instructions to cause, in response to a determination that the second gap is either less than the first threshold gap or greater than the second threshold gap, the ACC system to remain in a current status of the ACC system. That is, having the second gap be less than the first threshold gap can be indicative, for example, that the preferred setting associated with the second gap is not a safe setting and, therefore, the ACC system is maintained at the current setting. That is, having the second gap be greater than the second threshold gap can result in the preferred setting being beyond a setting capability of the ACC system and, therefore, the ACC system is maintained at the current setting.

Alternatively, for example, in a fourth realization of the second implementation of the disclosed technologies, the memory 304 can further store the gap determination module 314. For example, the gap determination module 314 can include instructions that function to control the processor 302 to determine if the second gap is either less than a first threshold gap or greater than a second threshold gap. For example, the instructions to cause the ACC system to utilize the information about the intent of the operator can include instructions to cause, in response to a determination that the second gap is: (1) less than the first threshold gap, the ACC system to use a value of the first threshold gap as a value of the preferred setting and (2) greater than the second threshold gap, the ACC system to use a value of the second threshold gap as the value of the preferred setting. That is, having the second gap be less than the first threshold gap can be indicative, for example, that the preferred setting associated with the second gap is not a safe setting and, therefore, the preferred setting is set to the value of the first threshold gap. That is, because having the second gap being greater than the second threshold gap can result in the preferred setting being beyond a setting capability of the ACC system, the preferred setting can be set to the value of the second threshold gap.

For example, in a third implementation of the disclosed technologies, the motion-related aspect of the vehicle can be a rate of a change of a speed of the ego vehicle. For example, the current setting can be for a first rate, controlled by the ACC system, of the change of the speed of the ego vehicle. For example, the preferred setting can be for a second rate, to be controlled by the ACC system, of the change of the speed of the ego vehicle. For example, the memory 304 can further store the motion-related aspect determination module 312. For example, the motion-related aspect determination module 312 can include instructions that function to control the processor 302 to determine that the motion-related aspect of the ego vehicle is the rate of the change of the speed of the ego vehicle.

With reference to FIG. 1, for example: (1) the ego vehicle can be the fourth vehicle 124, (2) the current setting, for the rate of the change of the speed of the fourth vehicle 124, can be represented by a sequence of circles, and (3) the preferred setting, for the rate of the change of the speed of the fourth vehicle 124, can be represented by a sequence of squares. Alternatively, for example: (1) the ego vehicle can be the second vehicle 120, (2) the current setting, for the rate of the change of the speed of the second vehicle 120, can be represented by a sequence of circles, and (3) the preferred setting, for the rate of the change of the speed of the second vehicle 120, can be represented by a sequence of squares.

Returning to FIG. 3, for example, the instructions to determine that the motion-related aspect of the ego vehicle is the rate of the change of the speed of the ego vehicle can include instructions to determine that a gap between the ego vehicle and a preceding vehicle is greater than a threshold gap.

With reference to FIG. 1, for example, the ego vehicle can be the fourth vehicle 124, the preceding vehicle can be the third vehicle 122, and the gap g₆ between the fourth vehicle 124 and the third vehicle 122 can be greater than the threshold gap, which can be indicative that the motion-related aspect of the fourth vehicle 124 is not the gap between the fourth vehicle 124 and the third vehicle 122, but is the rate of the change of the speed of the fourth vehicle 124. Likewise, for example, the ego vehicle can be the second vehicle 120, the preceding vehicle can be the first vehicle 118, and the gap g₇ between the second vehicle 120 and the first vehicle 118 can be greater than the threshold gap, which can be indicative that the motion-related aspect of the second vehicle 120 is not the gap between the second vehicle 120 and the first vehicle 118, but is the rate of the change of the speed of the second vehicle 120.

Returning to FIG. 3, additionally or alternatively, for example, the ACC system can include a database that has a record for a value of the current setting for the rate of the change of the speed of the ego vehicle. For example, the instructions to cause the ACC system to utilize the information about the intent of the operator can include: (1) instructions to determine a value of the rate of the change of the speed of the ego vehicle during the override, (2) instructions to overwrite, in the record, the value of the current setting with a value of the preferred setting, and (3) instructions to cause a resumption of the operation of the ACC system.

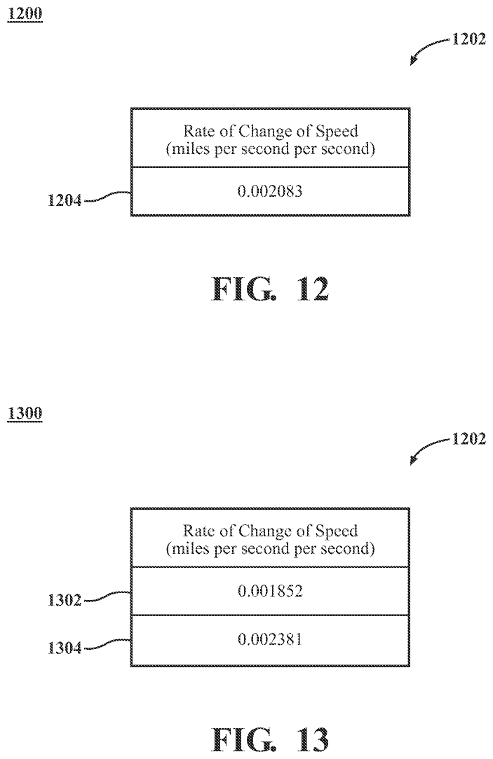

FIG. 12 includes a diagram that illustrates a first example 1200 of a database 1202 of the adaptive cruise control system, according to the disclosed technologies. For example, the database 1202 can be the database 236 illustrated in FIG. 2. For example, the database 1202 can include a record 1204 for the value of the current setting for the rate of the change of the speed of the ego vehicle. For example, if: (1) the value of the current setting for the rate of the change of the speed of the ego vehicle, in the record 1204, is 0.002083 miles per second per second and (2) the value of the rate of the change of the speed of the ego vehicle during the override is 0.002381 miles per second per second, then: (1) the value of the rate of the change of the speed of the ego vehicle during the override can be overwritten, in the record 1204, with the value of the preferred setting, 0.002381 miles per second per second and (2) the operation of the ACC system can be resumed.

Returning to FIG. 3, additionally or alternatively, for example, the ACC system can include a database that has: (1) a first record for a value of the current setting for the rate of the change of the speed of the ego vehicle if the current setting is positive (i.e., accelerating) and (2) a second record for the value of the current setting for the rate of the change of the speed of the ego vehicle if the current setting is negative (i.e., decelerating). For example, the instructions to cause the ACC system to utilize the information about the intent of the operator can include: (1) instructions to determine a value of the rate of the change of the speed of the ego vehicle during the override, (2) instructions to overwrite, in either the first record or the second record, the value of the current setting with a value of the preferred setting, and (3) instructions to cause a resumption of the operation of the ACC system.

FIG. 13 includes a diagram that illustrates a second example 1300 of the database 1202 of the adaptive cruise control system, according to the disclosed technologies. For example, the database 1202 can be the database 236 illustrated in FIG. 2. For example, the database 1202 can include: (1) a first record 1302 for the value of the current setting for the rate of the change of the speed of the ego vehicle if the current setting is positive (i.e., accelerating) and (2) a second record 1304 for the value of the current setting for the rate of the change of the speed of the ego vehicle if the current setting is negative (i.e., decelerating). For example, if: (1) the value of the current setting for the rate of the change of the speed of the ego vehicle, in the first record 1302, is 0.001852 miles per second per second and (2) the value of the rate of the change of the speed of the ego vehicle during the override is 0.002083 miles per second per second, then: (1) the value of the rate of the change of the speed of the ego vehicle during the override can be overwritten, in the first record 1302, with the value of the preferred setting, 0.002083 miles per second per second and (2) the operation of the ACC system can be resumed. Alternatively, for example, if: (1) the value of the current setting for the rate of the change of the speed of the ego vehicle, in the second record 1304, is 0.002381 miles per second per second and (2) the value of the rate of the change of the speed of the ego vehicle during the override is 0.002083 miles per second per second, then: (1) the value of the rate of the change of the speed of the ego vehicle during the override can be overwritten, in the second record 1304, with the value of the preferred setting, 0.002083 miles per second per second and (2) the operation of the ACC system can be resumed.

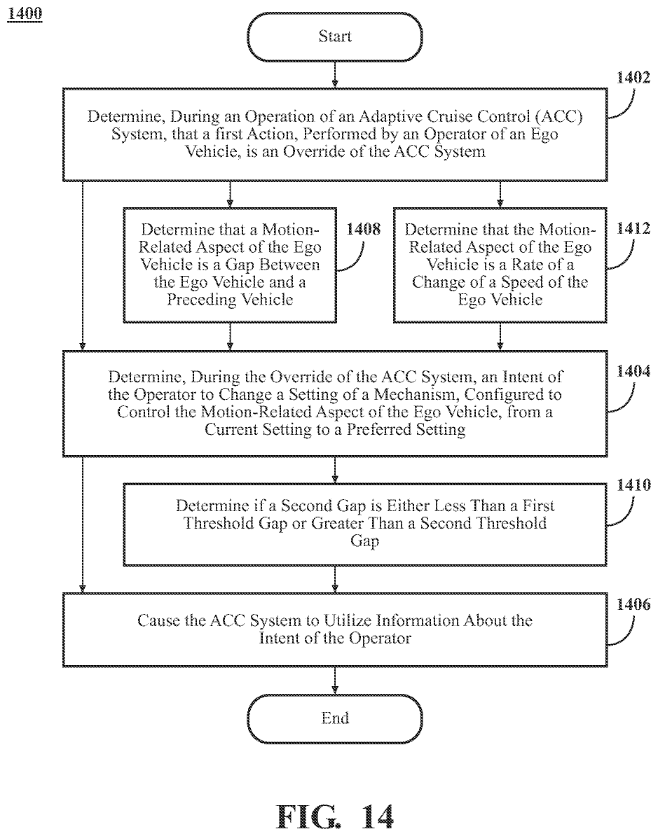

FIG. 14 includes a flow diagram that illustrates an example of a method 1400 that is associated with controlling an adaptive cruise control system, according to the disclosed technologies. Although the method 1400 is described in combination with the system 300 illustrated in FIG. 3, one of skill in the art understands, in light of the description herein, that the method 1400 is not limited to being implemented by the system 300 illustrated in FIG. 3. Rather, the system 300 illustrated in FIG. 3 is an example of a system that may be used to implement the method 1400. Additionally, although the method 1400 is illustrated as a generally serial process, various aspects of the method 1400 may be able to be executed in parallel.

In FIG. 14, in the method 1400, at an operation 1402, for example, the override ascertainment module 306 can determine, during an operation of the adaptive cruise control (ACC) system, that a first action, performed by an operator of an ego vehicle, is an override of the ACC system.

For example, the first action can include one or more of an action, via: (1) a braking operator interface, to cause the ego vehicle to brake or (2) an accelerating operator interface, to cause the ego vehicle to accelerate.

For example, one or more of: (1) the braking operator interface can include a brake pedal or (2) the accelerating operator interface can include an accelerator pedal.

Additionally or alternatively, for example, one or more of: (1) the braking operator interface can include a joystick-like control lever or (2) the accelerating operator interface can include the joystick-like control lever.

For example, in a first realization of a first implementation of the disclosed technologies, at the operation 1402, the override ascertainment module 306 can determine that the first action is performed for a duration of time greater than a threshold duration of time. For example, the threshold duration of time can be one second.

For example, in a second realization of the first implementation of the disclosed technologies, at the operation 1402, the override ascertainment module 306 can determine that the first action is performed for a duration of time less than a threshold duration of time. For example, the threshold duration of time can be three seconds.

For example, in a third realization of the first implementation of the disclosed technologies, at the operation 1402, the override ascertainment module 306 can determine that the first action is, within a duration of time less than a threshold duration of time, repeated. For example, the threshold duration of time can be two seconds.

For example, in a fourth realization of the first implementation of the disclosed technologies, at the operation 1402, the override ascertainment module 306 can determine that the first action is, within a duration of time less than a threshold duration of time, repeated greater than a threshold number of times. For example, the threshold duration of time can be one second. For example, the threshold number of times can be one.

At an operation 1404, for example, the intent ascertainment module 308 can determine, during the override of the ACC system, an intent of the operator to change a setting of a mechanism, configured to control a motion-related aspect of the ego vehicle, from a current setting to a preferred setting. For example, the mechanism can be of the adaptive cruise control system.

At an operation 1406, for example, the intent utilization module 310 can cause the ACC system to utilize information about the intent of the operator.

For example, in a second implementation of the disclosed technologies, the motion-related aspect of the ego vehicle can be a gap between the ego vehicle and a preceding vehicle. For example, the current setting can be for a first gap maintained, by the ACC system, between the ego vehicle and the preceding vehicle. For example, the preferred setting can be for a second gap to be maintained, by the ACC system, between the ego vehicle and the preceding vehicle. For example, at an operation 1408, the motion-related aspect determination module 312 can determine that the motion-related aspect of the ego vehicle is the gap between the ego vehicle and the preceding vehicle.

For example, in a first realization of the second implementation of the disclosed technologies, at the operation 1408, the motion-related aspect determination module 312 can determine that the gap between the ego vehicle and the preceding vehicle is less than a threshold gap. For example, the threshold gap can be a specific value. For example, the specific value can be 750 feet. Alternatively, for example, the threshold gap can be a function of a speed of the ego vehicle.

For example, in a second realization of the second implementation of the disclosed technologies, the ACC system can include a database that has records with a first field and a second field. For example, the first field can be for values of speeds of the ego vehicle. For example, the second field can be for values of settings for gaps to be maintained between the ego vehicle and the preceding vehicle.

For example, at the operation 1406, the intent utilization module 310 can: (1) determine a value of a speed of the ego vehicle during the override, (2) retrieve, from the database, a record, of the records, in which a value of a speed of the ego vehicle is equal to the value of the speed of the ego vehicle during the override, (3) overwrite, in the record, a value of a setting for a gap to be maintained between the ego vehicle and the preceding vehicle with a value of the preferred setting, and (4) cause a resumption of the operation of the ACC system.

Additionally, for example, at the operation 1406, the intent utilization module 310 can further: (5) compare the value of the preferred setting with a value of a safe setting for the gap to be maintained and (6) cause, in response to the value of the preferred setting being less than the value of the safe setting, the value of the preferred setting to be the value of the safe setting.

For example, in a first manifestation of the second realization of the second implementation of the disclosed technologies, at the operation 1404, the intent ascertainment module 308 can produce a first recording of values of gaps between the ego vehicle and the preceding vehicle. For example, the first recording can start at a time of an initiation of the first action. For example, the first recording can end at a time that is a duration of time after a time of a completion of the first action. For example, the duration of time can be two seconds. For example, the completion of the first action can include one or more of a cessation of an action, via: (1) a braking operator interface, to cause the ego vehicle to brake or (2) an accelerating operator interface, to cause the ego vehicle to accelerate. For example, at the operation 1406, the intent utilization module 310 can produce a second recording of the values of the speeds of the ego vehicle. For example, the second recording can start at the time of the initiation of the first action. For example, the second recording can end at the time that is the duration of time after the time of the completion of the first action.

Additionally, for example, at the operation 1404, the intent ascertainment module 308 can perform an analysis of the first recording. For example, the analysis of the first recording can be configured to emphasize a value, at the time of the completion of the first action, of a gap between the ego vehicle and the preceding vehicle. For example, at the operation 1406, the intent utilization module 310 can further perform an analysis of the second recording. For example, the analysis of the second recording can be configured to emphasize a value, at the time of the completion of the first action, of the speed of the ego vehicle.

Additionally or alternatively, for example, at the operation 1406, the intent utilization module 310 can further process, with a smoothing filter: (1) the first recording to produce smoothed values of the gaps between the ego vehicle and the preceding vehicle and (2) the second recording to produce smoothed values of the speeds of the ego vehicle. For example, the smoothing filter can be a moving average smoothing filter. For example, at the operation 1406, the intent utilization module 310 can retrieve records in which the values of the speeds of the ego vehicle are equal to the smoothed values of the speeds of the ego vehicle. For example, at the operation 1406, the intent utilization module 310 can overwrite, in the records in which the values of the speeds of the ego vehicle are equal to the smoothed values of the speeds of the ego vehicle, with the smoothed values of the gaps between the ego vehicle and the preceding vehicle.

For example, in a second manifestation of the second realization of the second implementation of the disclosed technologies, at the operation 1406, the intent utilization module 310 can retrieve records in which the values of the speeds of the ego vehicle are between a difference and a sum. For example, the difference can be of a threshold value subtracted from the value of the speed of the ego vehicle during the override. For example, the sum can be of the threshold value added to the value of the speed of the ego vehicle during the override. For example, the threshold value can be ten miles per hour.

For example, at the operation 1406, the intent utilization module 310 can further process, using a Gaussian process regression technique, values of the settings for the gaps to be maintained between the ego vehicle and the preceding vehicle, in the records in which the values of the speeds of the ego vehicle are between the difference and the sum, to produce updated values of the gaps to be maintained between the ego vehicle and the preceding vehicle. For example, at the operation 1406, the intent utilization module 310 can overwrite, in the records in which the values of the speeds of the ego vehicle are between the difference and the sum, with the updated values of the gaps to be maintained between the ego vehicle and the preceding vehicle.

For example, in a third manifestation of the second realization of the second implementation of the disclosed technologies, at the operation 1406, the intent utilization module 310 can cause, after the value of the setting for the gap to be maintained between the ego vehicle and the preceding vehicle has been overwritten with the value of the preferred setting, the resumption of the operation of the ACC system.

Additionally or alternatively, for example, in a fourth manifestation of the second realization of the second implementation of the disclosed technologies, at the operation 1406, the intent utilization module 310 can cause, in response to a second action, performed by the operator, the resumption of the operation of the ACC system. For example, the second action can include one or more of an action, via: (1) an ACC operator interface, to cause the resumption of the operation of the adaptive cruise control system, (2) a braking operator interface, to cause the ego vehicle to brake, or (3) an accelerating operator interface, to cause the ego vehicle to accelerate. For example, the ACC operator interface can include a resume button.

For example, in a third realization of the second implementation of the disclosed technologies, at an operation 1410, the gap determination module 314 can determine if the second gap is either less than a first threshold gap or greater than a second threshold gap. For example, at the operation 1406, the intent utilization module 310 can cause, in response to a determination that the second gap is either less than the first threshold gap or greater than the second threshold gap, the ACC system to remain in a current status of the ACC system.

Alternatively, for example, in a fourth realization of the second implementation of the disclosed technologies, at the operation 1410, the gap determination module 314 can determine if the second gap is either less than a first threshold gap or greater than a second threshold gap. For example, at the operation 1406, the intent utilization module 310 can cause, in response to a determination that the second gap is: (1) less than the first threshold gap, the ACC system to use a value of the first threshold gap as a value of the preferred setting and (2) greater than the second threshold gap, the ACC system to use a value of the second threshold gap as the value of the preferred setting.

For example, in a third implementation of the disclosed technologies, the motion-related aspect of the vehicle can be a rate of a change of a speed of the ego vehicle. For example, the current setting can be for a first rate, controlled by the ACC system, of the change of the speed of the ego vehicle. For example, the preferred setting can be for a second rate, to be controlled by the ACC system, of the change of the speed of the ego vehicle. For example, at an operation 1412, the motion-related aspect determination module 312 can determine that the motion-related aspect of the ego vehicle is the rate of the change of the speed of the ego vehicle.

For example, at the operation 1412, the motion-related aspect determination module 312 can determine that a gap between the ego vehicle and a preceding vehicle is greater than a threshold gap.

Additionally or alternatively, for example, the ACC system can include a database that has a record for a value of the current setting for the rate of the change of the speed of the ego vehicle. For example, at the operation 1406, the intent utilization module 310 can: (1) determine a value of the rate of the change of the speed of the ego vehicle during the override, (2) overwrite, in the record, the value of the current setting with a value of the preferred setting, and (3) cause a resumption of the operation of the ACC system.

Additionally or alternatively, for example, the ACC system can include a database that has: (1) a first record for a value of the current setting for the rate of the change of the speed of the ego vehicle if the current setting is positive (i.e., accelerating) and (2) a second record for the value of the current setting for the rate of the change of the speed of the ego vehicle if the current setting is negative (i.e., decelerating). For example, at the operation 1406, the intent utilization module 310 can: (1) determine a value of the rate of the change of the speed of the ego vehicle during the override, (2) overwrite, in either the first record or the second record, the value of the current setting with a value of the preferred setting, and (3) cause a resumption of the operation of the ACC system.

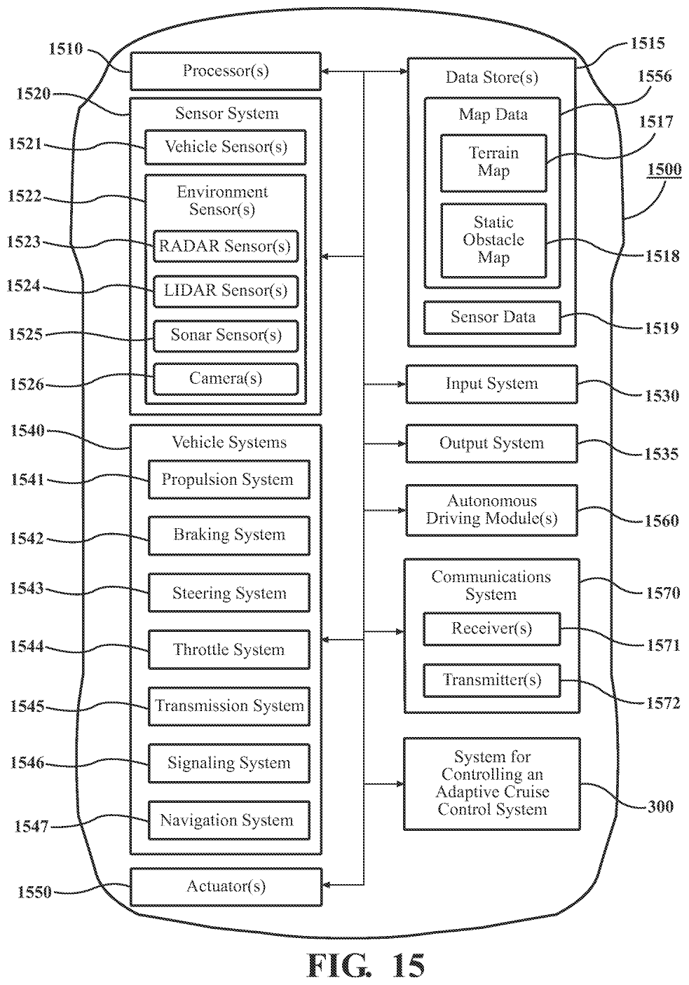

FIG. 15 includes a block diagram that illustrates an example of elements disposed on a vehicle 1500, according to the disclosed technologies. As used herein, a “vehicle” can be any form of powered transport. In one or more implementations, the vehicle 1500 can be an automobile. While arrangements described herein are with respect to automobiles, one of skill in the art understands, in light of the description herein, that embodiments are not limited to automobiles. For example, functions and/or operations of one or more of the first vehicle 118 (illustrated in FIG. 1), the second vehicle 120 (illustrated in FIG. 1), the third vehicle 122 (illustrated in FIG. 1), the fourth vehicle 124 (illustrated in FIG. 1), the fifth vehicle 126 (illustrated in FIG. 1), the sixth vehicle 128 (illustrated in FIG. 1), the seventh vehicle 130 (illustrated in FIG. 1), the eighth vehicle 132 (illustrated in FIG. 1), the ninth vehicle 134 (illustrated in FIG. 1), or the vehicle 200 (illustrated in FIG. 2) can be realized by the vehicle 1500.

In some embodiments, the vehicle 1500 can be configured to switch selectively between an automated mode, one or more semi-automated operational modes, and/or a manual mode. Such switching can be implemented in a suitable manner, now known or later developed. As used herein, “manual mode” can refer that all of or a majority of the navigation and/or maneuvering of the vehicle 1500 is performed according to inputs received from a user (e.g., human driver). In one or more arrangements, the vehicle 1500 can be a conventional vehicle that is configured to operate in only a manual mode.

In one or more embodiments, the vehicle 1500 can be an automated vehicle. As used herein, “automated vehicle” can refer to a vehicle that operates in an automated mode. As used herein, “automated mode” can refer to navigating and/or maneuvering the vehicle 1500 along a travel route using one or more computing systems to control the vehicle 1500 with minimal or no input from a human driver. In one or more embodiments, the vehicle 1500 can be highly automated or completely automated. In one embodiment, the vehicle 1500 can be configured with one or more semi-automated operational modes in which one or more computing systems perform a portion of the navigation and/or maneuvering of the vehicle along a travel route, and a vehicle operator (i.e., driver) provides inputs to the vehicle 1500 to perform a portion of the navigation and/or maneuvering of the vehicle 1500 along a travel route.

For example, Standard J3016 202104, Taxonomy and Definitions for Terms Related to Driving Automation Systems for On-Road Motor Vehicles, issued by the Society of Automotive Engineers (SAE) International on Jan. 16, 2014, and most recently revised on Apr. 30, 2021, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

The vehicle 1500 can include various elements. The vehicle 1500 can have any combination of the various elements illustrated in FIG. 15. In various embodiments, it may not be necessary for the vehicle 1500 to include all of the elements illustrated in FIG. 15. Furthermore, the vehicle 1500 can have elements in addition to those illustrated in FIG. 15. While the various elements are illustrated in FIG. 15 as being located within the vehicle 1500, one or more of these elements can be located external to the vehicle 1500. Furthermore, the elements illustrated may be physically separated by large distances. For example, as described, one or more components of the disclosed system can be implemented within the vehicle 1500 while other components of the system can be implemented within a cloud-computing environment, as described below. For example, the elements can include one or more processors 1510, one or more data stores 1515, a sensor system 1520, an input system 1530, an output system 1535, vehicle systems 1540, one or more actuators 1550, one or more automated driving modules 1560, a communications system 1570, and the system 300 for controlling the adaptive cruise control system.

In one or more arrangements, the one or more processors 1510 can be a main processor of the vehicle 1500. For example, the one or more processors 1510 can be an electronic control unit (ECU). For example, functions and/or operations of the processor 226 (illustrated in FIG. 2) or the processor 302 (illustrated in FIG. 3) can be realized by the one or more processors 1510.

The one or more data stores 1515 can store, for example, one or more types of data. The one or more data stores 1515 can include volatile memory and/or non-volatile memory. Examples of suitable memory for the one or more data stores 1515 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 1515 can be a component of the one or more processors 1510. Additionally or alternatively, the one or more data stores 1515 can be operatively connected to the one or more processors 1510 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation. For example, functions and/or operations of the memory 228 (illustrated in FIG. 2) or the memory 304 (illustrated in FIG. 3) can be realized by the one or more data stores 1515.

In one or more arrangements, the one or more data stores 1515 can store map data 1516. The map data 1516 can include maps of one or more geographic areas. In some instances, the map data 1516 can include information or data on roads, traffic control devices, road markings, structures, features, and/or landmarks in the one or more geographic areas. The map data 1516 can be in any suitable form. In some instances, the map data 1516 can include aerial views of an area. In some instances, the map data 1516 can include ground views of an area, including 360-degree ground views. The map data 1516 can include measurements, dimensions, distances, and/or information for one or more items included in the map data 1516 and/or relative to other items included in the map data 1516. The map data 1516 can include a digital map with information about road geometry. The map data 1516 can be high quality and/or highly detailed.

In one or more arrangements, the map data 1516 can include one or more terrain maps 1517. The one or more terrain maps 1517 can include information about the ground, terrain, roads, surfaces, and/or other features of one or more geographic areas. The one or more terrain maps 1517 can include elevation data of the one or more geographic areas. The map data 1516 can be high quality and/or highly detailed. The one or more terrain maps 1517 can define one or more ground surfaces, which can include paved roads, unpaved roads, land, and other things that define a ground surface.

In one or more arrangements, the map data 1516 can include one or more static obstacle maps 1518. The one or more static obstacle maps 1518 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 1518 can have location data, size data, dimension data, material data, and/or other data associated with them. The one or more static obstacle maps 1518 can include measurements, dimensions, distances, and/or information for one or more static obstacles. The one or more static obstacle maps 1518 can be high quality and/or highly detailed. The one or more static obstacle maps 1518 can be updated to reflect changes within a mapped area.

In one or more arrangements, the one or more data stores 1515 can store sensor data 1519. As used herein, “sensor data” can refer to any information about the sensors with which the vehicle 1500 can be equipped including the capabilities of and other information about such sensors. The sensor data 1519 can relate to one or more sensors of the sensor system 1520. For example, in one or more arrangements, the sensor data 1519 can include information about one or more lidar sensors 1524 of the sensor system 1520.

In some arrangements, at least a portion of the map data 1516 and/or the sensor data 1519 can be located in one or more data stores 1515 that are located onboard the vehicle 1500. Additionally or alternatively, at least a portion of the map data 1516 and/or the sensor data 1519 can be located in one or more data stores 1515 that are located remotely from the vehicle 1500.

The sensor system 1520 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 1520 includes a plurality of sensors, the sensors can work independently from each other. Alternatively, two or more of the sensors can work in combination with each other. In such a case, the two or more sensors can form a sensor network. The sensor system 1520 and/or the one or more sensors can be operatively connected to the one or more processors 1510, the one or more data stores 1515, and/or another element of the vehicle 1500 (including any of the elements illustrated in FIG. 15). The sensor system 1520 can acquire data of at least a portion of the external environment of the vehicle 1500 (e.g., nearby vehicles). The sensor system 1520 can include any suitable type of sensor. Various examples of different types of sensors are described herein. However, one of skill in the art understands that the embodiments are not limited to the particular sensors described herein.

The sensor system 1520 can include one or more vehicle sensors 1521. The one or more vehicle sensors 1521 can detect, determine, and/or sense information about the vehicle 1500 itself. In one or more arrangements, the one or more vehicle sensors 1521 can be configured to detect and/or sense position and orientation changes of the vehicle 1500 such as, for example, based on inertial acceleration. In one or more arrangements, the one or more vehicle sensors 1521 can include one or more accelerometers, one or more gyroscopes, an inertial measurement unit (IMU), a dead-reckoning system, a global navigation satellite system (GNSS), a global positioning system (GPS), a navigation system 1547, and/or other suitable sensors. The one or more vehicle sensors 1521 can be configured to detect and/or sense one or more characteristics of the vehicle 1500. In one or more arrangements, the one or more vehicle sensors 1521 can include a speedometer to determine a current speed of the vehicle 1500.

Additionally or alternatively, the sensor system 1520 can include one or more environment sensors 1522 configured to acquire and/or sense driving environment data. As used herein, “driving environment data” can include data or information about the external environment in which a vehicle is located or one or more portions thereof. For example, the one or more environment sensors 1522 can be configured to detect, quantify, and/or sense obstacles in at least a portion of the external environment of the vehicle 1500 and/or information/data about such obstacles. Such obstacles may be stationary objects and/or dynamic objects. The one or more environment sensors 1522 can be configured to detect, measure, quantify, and/or sense other things in the external environment of the vehicle 1500 such as, for example, lane markers, signs, traffic lights, traffic signs, lane lines, crosswalks, curbs proximate the vehicle 1500, off-road objects, etc. For example, functions and/or operations of the sensor 230 (illustrated in FIG. 2) can be realized by the one or more environment sensors 1522.

Various examples of sensors of the sensor system 1520 are described herein. The example sensors may be part of the one or more vehicle sensors 1521 and/or the one or more environment sensors 1522. However, one of skill in the art understands that the embodiments are not limited to the particular sensors described.

In one or more arrangements, the one or more environment sensors 1522 can include one or more radar sensors 1523, one or more lidar sensors 1524, one or more sonar sensors 1525, and/or one more cameras 1526. In one or more arrangements, the one or more cameras 1526 can be one or more high dynamic range (HDR) cameras or one or more infrared (IR) cameras. For example, the one or more cameras 1526 can be used to record a reality of a state of an item of information that can appear in the digital map.

The input system 1530 can include any device, component, system, element, arrangement, or groups thereof that enable information/data to be entered into a machine. The input system 1530 can receive an input from a vehicle passenger (e.g., a driver or a passenger). The output system 1535 can include any device, component, system, element, arrangement, or groups thereof that enable information/data to be presented to a vehicle passenger (e.g., a driver or a passenger). For example, functions and/or operations of the adaptive cruise control operator interface 238 (illustrated in FIG. 2) or the resume button 240 (illustrated in FIG. 2) can be realized by the input system 1530.

Various examples of the one or more vehicle systems 1540 are illustrated in FIG. 15. However, one of skill in the art understands that the vehicle 1500 can include more, fewer, or different vehicle systems. Although particular vehicle systems can be separately defined, each or any of the systems or portions thereof may be otherwise combined or segregated via hardware and/or software within the vehicle 1500. For example, the one or more vehicle systems 1540 can include a propulsion system 1541, a braking system 1542, a steering system 1543, a throttle system 1544, a transmission system 1545, a signaling system 1546, and/or the navigation system 1547. Each of these systems can include one or more devices, components, and/or a combination thereof, now known or later developed. For example, functions and/or operations of the internal combustion engine 204 (illustrated in FIG. 2) or the electric drive motor 206 (illustrated in FIG. 2) can be realized by the propulsion system 1541. For example, functions and/or operations of the brakes 208 (illustrated in FIG. 2) can be realized by the braking system 1542.

The navigation system 1547 can include one or more devices, applications, and/or combinations thereof, now known or later developed, configured to determine the geographic location of the vehicle 1500 and/or to determine a travel route for the vehicle 1500. The navigation system 1547 can include one or more mapping applications to determine a travel route for the vehicle 1500. The navigation system 1547 can include a global positioning system, a local positioning system, a geolocation system, and/or a combination thereof.

The one or more actuators 1550 can be any element or combination of elements operable to modify, adjust, and/or alter one or more of the vehicle systems 1540 or components thereof responsive to receiving signals or other inputs from the one or more processors 1510 and/or the one or more automated driving modules 1560. Any suitable actuator can be used. For example, the one or more actuators 1550 can include motors, pneumatic actuators, hydraulic pistons, relays, solenoids, and/or piezoelectric actuators. For example, functions and/or operations of the actuator 210 (illustrated in FIG. 2), the actuator 212 (illustrated in FIG. 2), or the actuator 214 (illustrated in FIG. 2) can be realized by the one or more actuators 1550.

The one or more processors 1510 and/or the one or more automated driving modules 1560 can be operatively connected to communicate with the various vehicle systems 1540 and/or individual components thereof. For example, the one or more processors 1510 and/or the one or more automated driving modules 1560 can be in communication to send and/or receive information from the various vehicle systems 1540 to control the movement, speed, maneuvering, heading, direction, etc. of the vehicle 1500. The one or more processors 1510 and/or the one or more automated driving modules 1560 may control some or all of these vehicle systems 1540 and, thus, may be partially or fully automated.

The one or more processors 1510 and/or the one or more automated driving modules 1560 may be operable to control the navigation and/or maneuvering of the vehicle 1500 by controlling one or more of the vehicle systems 1540 and/or components thereof. For example, when operating in an automated mode, the one or more processors 1510 and/or the one or more automated driving modules 1560 can control the direction and/or speed of the vehicle 1500. The one or more processors 1510 and/or the one or more automated driving modules 1560 can cause the vehicle 1500 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner.

The communications system 1570 can include one or more receivers 1571 and/or one or more transmitters 1572. The communications system 1570 can receive and transmit one or more messages through one or more wireless communications channels. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 1570 can include “connected vehicle” technology. “Connected vehicle” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V2I) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies.

Moreover, the one or more processors 1510, the one or more data stores 1515, and the communications system 1570 can be configured to one or more of form a micro cloud, participate as a member of a micro cloud, or perform a function of a leader of a micro cloud. A micro cloud can be characterized by a distribution, among members of the micro cloud, of one or more of one or more computing resources or one or more data storage resources in order to collaborate on executing operations. The members can include at least connected vehicles.

The vehicle 1500 can include one or more modules, at least some of which are described herein. The modules can be implemented as computer-readable program code that, when executed by the one or more processors 1510, implement one or more of the various processes described herein. One or more of the modules can be a component of the one or more processors 1510. Additionally or alternatively, one or more of the modules can be executed on and/or distributed among other processing systems to which the one or more processors 1510 can be operatively connected. The modules can include instructions (e.g., program logic) executable by the one or more processors 1510. Additionally or alternatively, the one or more data store 1515 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 1500 can include one or more automated driving modules 1560. The one or more automated driving modules 1560 can be configured to receive data from the sensor system 1520 and/or any other type of system capable of capturing information relating to the vehicle 1500 and/or the external environment of the vehicle 1500. In one or more arrangements, the one or more automated driving modules 1560 can use such data to generate one or more driving scene models. The one or more automated driving modules 1560 can determine position and velocity of the vehicle 1500. The one or more automated driving modules 1560 can determine the location of obstacles, obstacles, or other environmental features including traffic signs, trees, shrubs, neighboring vehicles, pedestrians, etc.

The one or more automated driving modules 1560 can be configured to receive and/or determine location information for obstacles within the external environment of the vehicle 1500 for use by the one or more processors 1510 and/or one or more of the modules described herein to estimate position and orientation of the vehicle 1500, vehicle position in global coordinates based on signals from a plurality of satellites, or any other data and/or signals that could be used to determine the current state of the vehicle 1500 or determine the position of the vehicle 1500 with respect to its environment for use in either creating a map or determining the position of the vehicle 1500 in respect to map data.

The one or more automated driving modules 1560 can be configured to determine one or more travel paths, current automated driving maneuvers for the vehicle 1500, future automated driving maneuvers and/or modifications to current automated driving maneuvers based on data acquired by the sensor system 1520, driving scene models, and/or data from any other suitable source such as determinations from the sensor data 1519. As used herein, “driving maneuver” can refer to one or more actions that affect the movement of a vehicle. Examples of driving maneuvers include: accelerating, decelerating, braking, turning, moving in a lateral direction of the vehicle 1500, changing travel lanes, merging into a travel lane, and/or reversing, just to name a few possibilities. The one or more automated driving modules 1560 can be configured to implement determined driving maneuvers. The one or more automated driving modules 1560 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The one or more automated driving modules 1560 can be configured to execute various vehicle functions and/or to transmit data to, receive data from, interact with, and/or control the vehicle 1500 or one or more systems thereof (e.g., one or more of vehicle systems 1540). For example, functions and/or operations of an automotive navigation system can be realized by the one or more automated driving modules 1560.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-15, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component (e.g., a central processing unit (CPU), a graphics processing unit (GPU), a field-programmable gate array (FPGA), or the like) that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing:
an override ascertainment module including instructions that, when executed by the processor, cause the processor to determine, during an operation of an adaptive cruise control system, that a first action, performed by an operator of an ego vehicle, is an override of the adaptive cruise control system;
an intent ascertainment module including instructions that, when executed by the processor, cause the processor to determine, during the override, an intent of the operator to change a setting of a mechanism, configured to control a motion-related aspect of the ego vehicle, from a current setting to a preferred setting, the mechanism being of the adaptive cruise control system; and
an intent utilization module including instructions that, when executed by the processor, cause the processor to cause the adaptive cruise control system to utilize information about the intent.

2. The system of claim 1, wherein:
the motion-related aspect of the ego vehicle is a gap between the ego vehicle and a preceding vehicle,
the current setting is for a first gap maintained, by the adaptive cruise control system, between the ego vehicle and the preceding vehicle,
the preferred setting is for a second gap to be maintained, by the adaptive cruise control system, between the ego vehicle and the preceding vehicle, and
the memory further stores a motion-related aspect determination module including instructions that, when executed by the processor, cause the processor to determine that the motion-related aspect of the ego vehicle is the gap between the ego vehicle and the preceding vehicle.

3. The system of claim 2, wherein the instructions to determine that the motion-related aspect of the ego vehicle is the gap between the ego vehicle and the preceding vehicle include instructions to determine that the gap between the ego vehicle and the preceding vehicle is less than a threshold gap.

4. The system of claim 2, wherein:
the adaptive cruise control system includes a database that has records with a first field and a second field, the first field being for values of speeds of the ego vehicle, the second field being for values of settings for gaps to be maintained between the ego vehicle and the preceding vehicle, and
the instructions to cause the adaptive cruise control system to utilize the information about the intent include:
instructions to determine a value of a speed of the ego vehicle during the override,
instructions to retrieve, from the database, a record, of the records, in which a value of a speed of the ego vehicle is equal to the value of the speed of the ego vehicle during the override,
instructions to overwrite, in the record, a value of a setting for a gap to be maintained between the ego vehicle and the preceding vehicle with a value of the preferred setting, and
instructions to cause a resumption of the operation of the adaptive cruise control system.

5. The system of claim 4, wherein:
the instructions to determine the intent include instructions to produce a first recording of values of gaps between the ego vehicle and the preceding vehicle, the first recording starting at a time of an initiation of the first action, the first recording ending at a time that is a duration of time after a time of a completion of the first action, and
the instructions to determine the value of the speed of the ego vehicle include instructions to produce a second recording of the values of the speeds of the ego vehicle, the second recording starting at the time of the initiation of the first action, the second recording ending at the time that is the duration of time after the time of the completion of the first action.

6. The system of claim 5, wherein:
the instructions to determine the intent further include instructions to perform an analysis of the first recording, wherein the analysis of the first recording is configured to emphasize a value, at the time of the completion of the first action, of a gap between the ego vehicle and the preceding vehicle, and
the instructions to determine the value of the speed of the ego vehicle further include instructions to perform an analysis of the second recording, wherein the analysis of the second recording is configured to emphasize a value, at the time of the completion of the first action, of the speed of the ego vehicle.

7. The system of claim 5, wherein:
the instructions to cause the adaptive cruise control system to utilize the information about the intent further include instructions to process, with a smoothing filter:
the first recording to produce smoothed values of the gaps between the ego vehicle and the preceding vehicle, and
the second recording to produce smoothed values of the speeds of the ego vehicle,
the instructions to retrieve the record include instructions to retrieve records in which the values of the speeds of the ego vehicle are equal to the smoothed values of the speeds of the ego vehicle, and
the instructions to overwrite the value of the setting for the gap to be maintained between the ego vehicle and the preceding vehicle include instructions to overwrite, in the records in which the values of the speeds of the ego vehicle are equal to the smoothed values of the speeds of the ego vehicle, with the smoothed values of the gaps between the ego vehicle and the preceding vehicle.

8. The system of claim 4, wherein:
the instructions to retrieve the record include instructions to retrieve records in which the values of the speeds of the ego vehicle are between:
a difference, the difference being of a threshold value subtracted from the value of the speed of the ego vehicle during the override, and
a sum, the sum being of the threshold value added to the value of the speed of the ego vehicle during the override,
the instructions to cause the adaptive cruise control system to utilize the information about the intent further include instructions to process, using a Gaussian process regression technique, values of the settings for the gaps to be maintained between the ego vehicle and the preceding vehicle, in the records in which the values of the speeds of the ego vehicle are between the difference and the sum, to produce updated values of the gaps to be maintained between the ego vehicle and the preceding vehicle, and
the instructions to overwrite the value of the setting for the gap to be maintained between the ego vehicle and the preceding vehicle include instructions to overwrite, in the records in which the values of the speeds of the ego vehicle are between the difference and the sum, with the updated values of the gaps to be maintained between the ego vehicle and the preceding vehicle.

9. The system of claim 4, wherein the instructions to cause the resumption of the operation of the adaptive cruise control system include instructions to cause, after the value of the setting for the gap to be maintained between the ego vehicle and the preceding vehicle has been overwritten with the value of the preferred setting, the resumption of the operation of the adaptive cruise control system.

10. The system of claim 4, wherein the instructions to cause the resumption of the operation of the adaptive cruise control system include instructions to cause, in response to a second action, performed by the operator, the resumption of the operation of the adaptive cruise control system.

11. The system of claim 2, wherein:
the memory further stores a gap determination module including instructions that, when executed by the processor, cause the processor to determine if the second gap is one of less than a first threshold gap or greater than a second threshold gap, and
the instructions to cause the adaptive cruise control system to utilize the information about the intent include instructions to cause, in response to a determination that the second gap is the one of less than the first threshold gap or greater than the second threshold gap, the adaptive cruise control system to remain in a current status of the adaptive cruise control system.

12. The system of claim 2, wherein:
the memory further stores a gap determination module including instructions that, when executed by the processor, cause the processor to determine if the second gap is one of less than a first threshold gap or greater than a second threshold gap,
the instructions to cause the adaptive cruise control system to utilize the information about the intent include instructions to cause, in response to a determination that the second gap is:
less than the first threshold gap, the adaptive cruise control system to use a value of the first threshold gap as a value of the preferred setting, and
greater than the second threshold gap, the adaptive cruise control system to use a value of the second threshold gap as the value of the preferred setting.

13. The system of claim 1, wherein:
the motion-related aspect of the ego vehicle is a rate of a change of a speed of the ego vehicle,
the current setting is for a first rate, controlled by the adaptive cruise control system, of the change of the speed of the ego vehicle, and
the preferred setting is for a second rate, to be controlled by the adaptive cruise control system, of the change of the speed of the ego vehicle, and
the memory further stores a motion-related aspect determination module including instructions that, when executed by the processor, cause the processor to determine that the motion-related aspect of the ego vehicle is the rate of the change of the speed of the ego vehicle.

14. The system of claim 13, wherein the instructions to determine that the motion-related aspect of the ego vehicle is the rate of the change of the speed of the ego vehicle include instructions to determine that a gap between the ego vehicle and a preceding vehicle is greater than a threshold gap.

15. The system of claim 13, wherein:
the adaptive cruise control system includes a database that has one of:
a first record for a value of the current setting,
a second record for the value of the current setting if the current setting is positive, or
a third record for the value of the current setting is the current setting is negative, and
the instructions to cause the adaptive cruise control system to utilize the information about the intent include:
instructions to determine a value of the rate of the change of the speed of the ego vehicle during the override,
instructions to overwrite, in the one of the first record, the second record, or the third record, the value of the current setting with a value of the preferred setting, and
instructions to cause a resumption of the operation of the adaptive cruise control system.

16. A method, comprising:
determining, by a processor during an operation of an adaptive cruise control system, that an action, performed by an operator of an ego vehicle, is an override of the adaptive cruise control system;
determining, by the processor and during the override, an intent of the operator to change a setting of a mechanism, configured to control a motion-related aspect of the ego vehicle, from a current setting to a preferred setting, the mechanism being of the adaptive cruise control system; and
causing, by the processor, the adaptive cruise control system to utilize information about the intent.

17. The method of claim 16, wherein the determining that the first action is the override comprises determining that the first action is performed for a duration of time greater than a threshold duration of time.

18. The method of claim 16, wherein the determining that the first action is the override comprises determining that the first action is performed for a duration of time less than a threshold duration of time.

19. The method of claim 16, wherein the determining that the first action is the override comprises determining that the first action is, within a duration of time less than a threshold duration of time, repeated.

20. A non-transitory computer-readable medium for controlling an adaptive cruise control system, the non-transitory computer-readable medium including instructions that, when executed by one or more processors, cause the one or more processors to:
determine, during an operation of an adaptive cruise control system, that an action, performed by an operator of an ego vehicle, is an override of the adaptive cruise control system;
determine, during the override, an intent of the operator to change a setting of a mechanism, configured to control a motion-related aspect of the ego vehicle, from a current setting to a preferred setting, the mechanism being of the adaptive cruise control system; and
cause the adaptive cruise control system to utilize information about the intent.
